(19) United States
(12) Patent Application Publication
(10) Pub. No.: US 2013/0169692 A1
(43) Pub. Date: Jul. 4, 2013

(54) DISPLAY DEVICE AND BRIGHTNESS CONTROL METHOD CAPABLE OF REDUCING POWER CONSUMPTION OF DISPLAY DEVICE

(71) Applicant: Chao-Hsin Wang, New Taipei City (TW)

(72) Inventor: Chao-Hsin Wang, New Taipei City (TW)

(21) Appl. No.: 13/430,717

(22) Filed: Mar. 27, 2012

(30) Foreign Application Priority Data
Dec. 29, 2011 (CN) 201110449611.0

(51) Int. Cl. G09G 5/10; G09G 3/36

(52) U.S. Cl. 345/690; 345/102

(57) ABSTRACT

A display device includes a display panel, a backlight module, a driving circuit and a control unit. The driving circuit is electrically connected to the backlight module and used for providing a driving voltage for the backlight module. The control unit is electrically connected to the display panel and the driving circuit. The control unit controls the driving voltage to vary within a predetermined ratio range periodically so as to make a backlight brightness of the backlight module vary periodically in response to the driving voltage within the predetermined ratio range and controls a display parameter of the display panel to vary periodically according to the backlight brightness of the backlight module so as to compensate the backlight brightness of the backlight module. Accordingly, the invention can reduce power consumption of the backlight module effectively so as to reduce power consumption of the display device.

### BACKGROUND OF THE INVENTION

1. Field of the Invention

The invention relates to a display device and, more particularly, to a brightness control method capable of reducing power consumption of a display device.

2. Description of the Prior Art

So far most of electronic devices, such as notebook, flat computer, mobile phone and so on, are usually equipped with a thin film transistor liquid crystal display (TFT-LCD). The LCD is a passive display device, which utilizes a backlight module to implement display function. The performance of the backlight module will influence image display quality immediately and power consumption of the backlight module is 75% of the LCD. That is to say, the backlight module consumes most of LCD's power. Therefore, how to reduce power consumption of the backlight module effectively without influencing visual effect while a user is watching the LCD is a significant design issue.

### SUMMARY OF THE INVENTION

An objective of the invention is to provide a display device and a brightness control method capable of reducing power consumption of the display device, so as to solve the aforesaid problems.

According to an embodiment of the invention, a display device comprises a display panel, a backlight module, a driving circuit and a control unit. The driving circuit is electrically connected to the backlight module and used for providing a driving voltage for the backlight module. The control unit is electrically connected to the display panel and the driving circuit. The control unit controls the driving voltage to vary within a predetermined ratio range periodically so as to make a backlight brightness of the backlight module vary periodically in response to the driving voltage within the predetermined ratio range and controls a display parameter of the display panel to vary periodically according to the backlight brightness of the backlight module so as to compensate the backlight brightness of the backlight module.

In this embodiment, the control unit may control the driving voltage to decrease from an upper bound of the predetermined ratio range to a lower bound of the predetermined ratio range and then control the driving voltage to increase from the lower bound of the predetermined ratio range to the upper bound of the predetermined ratio range during each cycle.

In this embodiment, the upper bound of the predetermined ratio range may be 100% and the lower bound of the predetermined ratio range may be 80%.

In this embodiment, a period of each cycle may be larger than or equal to one minute.

In this embodiment, the display parameter may comprise brightness, contrast, gamma value or combination thereof.

According to another embodiment, a brightness control method is capable of reducing power consumption of a display device, wherein the display device comprises a display panel and a backlight module. The brightness control method comprises steps of controlling a driving voltage of the backlight module to vary within a predetermined ratio range periodically so as to make a backlight brightness of the backlight module vary periodically in response to the driving voltage within the predetermined ratio range; and controlling a display parameter of the display panel to vary periodically according to the backlight brightness of the backlight module so as to compensate the backlight brightness of the backlight module.

In this embodiment the brightness control method may further comprise step of first controlling the driving voltage of the backlight module to decrease from an upper bound of the predetermined ratio range to a lower bound of the predetermined ratio range and then controlling the driving voltage to increase from the lower bound of the predetermined ratio range to the upper bound of the predetermined ratio range during each cycle.

In this embodiment, the upper bound of the predetermined ratio range may be 100% and the lower bound of the predetermined ratio range may be 80%.

In this embodiment, a period of each cycle may be larger than or equal to one minute.

In this embodiment, the display parameter may comprise brightness, contrast, gamma value or combination thereof.

As mentioned in the above, since the driving voltage of the backlight module varies within the predetermined ratio range periodically (e.g. the upper bound of the predetermined ratio range may be 100% and the lower bound of the predetermined ratio range may be 80% preferably), power consumption of the backlight module can be reduced effectively so as to reduce power consumption of the display device. Furthermore, the display parameter of the display device (e.g. brightness, contrast, gamma value or combination thereof) will vary periodically in response to the backlight brightness of the backlight module so as to compensate the backlight brightness of the backlight module, such that the display device can maintain constant display brightness. Therefore, the invention will not influence visual effect while a user is watching the display device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram illustrating a display device according to an embodiment of the invention.

FIG. 2 is a sequence diagram illustrating backlight brightness of the backlight module and display parameter of the display panel varying periodically.

FIG. 3 is a flowchart illustrating a brightness control method capable of reducing power consumption of the display device according to an embodiment of the invention.

### DETAILED DESCRIPTION

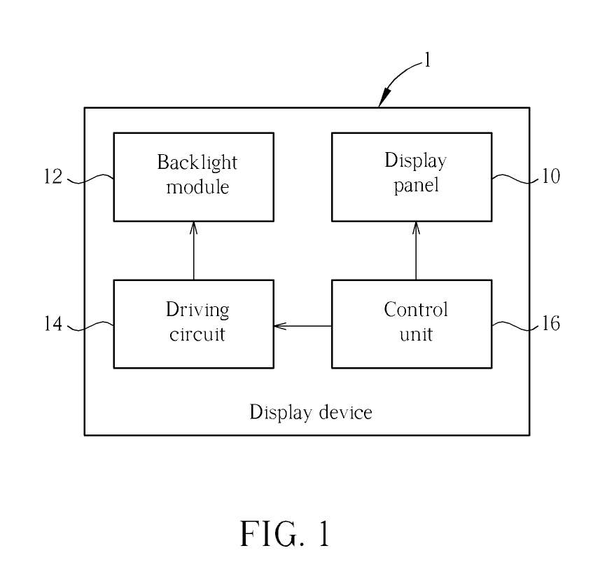

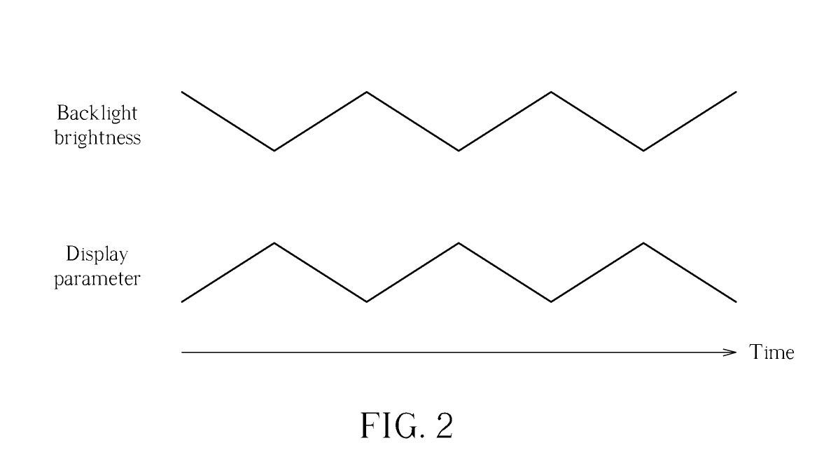

Referring to FIGS. 1 and 2, FIG. 1 is a functional block diagram illustrating a display device 1 according to an embodiment of the invention, and FIG. 2 is a sequence diagram illustrating backlight brightness of the backlight module 12 and display parameter of the display panel 10 varying periodically. As shown in FIG. 1, the display device 1 comprises a display panel 10, a backlight module 12, a driving circuit 14 and a control unit 16, wherein the driving circuit 14 is electrically connected to the backlight module 12 and the control unit 16 is electrically connected to the display panel 10 and the driving circuit 14. In this embodiment, the display device 1 may be an LCD device or other display devices with backlight module, the display panel 10 may be an LCD panel or other display panels collocated with backlight module, and the control unit 16 may be a control chip disposed on a main circuit board. The driving circuit 14 is used for providing a driving voltage for the backlight module 12 so as to drive the backlight module 12 to emit light toward the display panel 10.

To reduce power consumption of the backlight module 12 so as to reduce power consumption of the display device 1, the control unit 16 controls the driving voltage, which is provided by the driving circuit 14 for the backlight module 12, to vary within a predetermined ratio range periodically, so as to make backlight brightness of the backlight module 12 vary periodically in response to the driving voltage within the predetermined ratio range, as shown in FIG. 2. In this embodiment, the control unit 16 may control the driving voltage to decrease from an upper bound of the predetermined ratio range to a lower bound of the predetermined ratio range and then control the driving voltage to increase from the lower bound of the predetermined ratio range to the upper bound of the predetermined ratio range during each cycle, so as to make the backlight brightness of the backlight module 12 vary periodically in response to the driving voltage within the predetermined ratio range. Preferably, the upper bound of the predetermined ratio range may be 100%, the lower bound of the predetermined ratio range may be 80%, and a period of each cycle may be larger than or equal to one minute. For example, it is assumed that the driving voltage, which is provided by the driving circuit 14 for the backlight module 12, is 3.3 volts at 100% and 2.64 volts at 80% and the backlight brightness of the backlight module 12 is 300 nits corresponding to the driving voltage 3.3 volts and 270 nits corresponding to the driving voltage 2.64 volts. The control unit 16 may control the driving voltage to decrease from 3.3 volts to 2.64 volts and then control the driving voltage to increase from 2.64 volts to 3.3 volts during each cycle, so as to make the backlight brightness of the backlight module 12 decrease from 300 nits to 270 nits and then increase from 270 nits to 300 nits during each cycle.

It should be noted that the upper bound and the lower bound of the predetermined ratio range and the period of each cycle can be determined based on practical applications and are not limited to the aforesaid embodiment. In practical applications, the control unit 16 may control the driving voltage, which is provided by the driving circuit 14 for the backlight module 12, to vary periodically within the predetermined ratio range through pulse width modulation (PWM) signal.

According to experimental results, if the driving voltage of the backlight module 12 is maintained at 100%, the power consumption is about 166 watts; if the driving voltage of the backlight module 12 varies within a ratio range between 100% and 94%, the power consumption is about 149.4 watts; and if the driving voltage of the backlight module 12 varies within a ratio range between 100% and 88%, the power consumption is about 142.6 watts. In other words, the power consumption of the backlight module 12 can be reduced effectively so as to reduce the power consumption of the display device 1 as long as the driving voltage of the backlight module 12 is not always maintained at 100%.

Furthermore, to maintain visual effect while a user is watching the display device 1, the control unit 16 may control display parameter of the display panel 10 to vary periodically while the backlight brightness of the backlight module 12 varies during each cycle so as to compensate the backlight brightness of the backlight module 12. In this embodiment, the display parameter may comprise brightness, contrast, gamma value or combination thereof. In other words, the control unit 16 may adjust brightness, contrast, gamma value or combination thereof to compensate the backlight brightness of the backlight module 12 so as to maintain display brightness of the display device 1. Referring to the aforesaid example again, when the backlight brightness of the backlight module 12 decreases from 300 nits to 270 nits and then increases from 270 nits to 300 nits during each cycle, the control unit 16 can compensate the backlight brightness of the backlight module 12 by adjusting brightness, contrast, gamma value or combination thereof of the display panel 10 so as to maintain the display brightness of the display device 1 at 300 nits. Therefore, the invention will not influence visual effect of the display device 1 while reducing power consumption of the backlight module 12. In practical applications, the brightness, contrast, gamma value and combination thereof of the display panel 10 may be adjusted by gray levels of pixels.

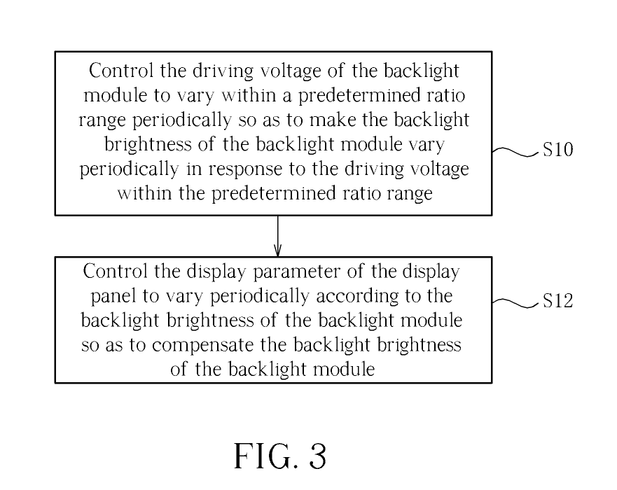

Referring to FIG. 3, FIG. 3 is a flowchart illustrating a brightness control method capable of reducing power consumption of the display device 1 according to an embodiment of the invention. As shown in FIG. 3, first of all, step S10 is performed to control the driving voltage of the backlight module 12 to vary within a predetermined ratio range periodically so as to make the backlight brightness of the backlight module 12 vary periodically in response to the driving voltage within the predetermined ratio range. Afterward, step S12 is performed to control the display parameter of the display panel 10 to vary periodically according to the backlight brightness of the backlight module 12 so as to compensate the backlight brightness of the backlight module 12. It should be noted that the embodiment of the brightness control method is mentioned in the above and will not be depicted herein again.

Compared with the prior art, since the driving voltage of the backlight module varies within the predetermined ratio range periodically (e.g. the upper bound of the predetermined ratio range may be 100% and the lower bound of the predetermined ratio range may be 80% preferably), power consumption of the backlight module can be reduced effectively so as to reduce power consumption of the display device. Furthermore, the display parameter of the display device (e.g. brightness, contrast, gamma value or combination thereof) will vary periodically in response to the backlight brightness of the backlight module so as to compensate the backlight brightness of the backlight module, such that the display device can maintain constant display brightness. Therefore, the invention will not influence visual effect while a user is watching the display device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display device comprising:
a display panel;
a backlight module;
a driving circuit electrically connected to the backlight module, the driving circuit being used for providing a driving voltage for the backlight module; and
a control unit electrically connected to the display panel and the driving circuit, the control unit controlling the driving voltage to vary within a predetermined ratio range periodically so as to make a backlight brightness of the backlight module vary periodically in response to the driving voltage within the predetermined ratio range and controlling a display parameter of the display panel to vary periodically according to the backlight brightness of the backlight module so as to compensate the backlight brightness of the backlight module.

2. The display device of claim 1, wherein the control unit controls the driving voltage to decrease from an upper bound of the predetermined ratio range to a lower bound of the predetermined ratio range and then controls the driving voltage to increase from the lower bound of the predetermined ratio range to the upper bound of the predetermined ratio range during each cycle.

3. The display device of claim 2, wherein the upper bound of the predetermined ratio range is 100% and the lower bound of the predetermined ratio range is 80%.

4. The display device of claim 2, wherein a period of each cycle is larger than or equal to one minute.

5. The display device of claim 1, wherein the display parameter comprises brightness, contrast, gamma value or combination thereof.

6. A brightness control method capable of reducing power consumption of a display device, the display device comprising a display panel and a backlight module, the brightness control method comprising:
controlling a driving voltage of the backlight module to vary within a predetermined ratio range periodically so as to make a backlight brightness of the backlight module vary periodically in response to the driving voltage within the predetermined ratio range; and
controlling a display parameter of the display panel to vary periodically according to the backlight brightness of the backlight module so as to compensate the backlight brightness of the backlight module.

7. The brightness control method of claim 6 further comprising:
first controlling the driving voltage of the backlight module to decrease from an upper bound of the predetermined ratio range to a lower bound of the predetermined ratio range and then controlling the driving voltage to increase from the lower bound of the predetermined ratio range to the upper bound of the predetermined ratio range during each cycle.

8. The brightness control method of claim 7, wherein the upper bound of the predetermined ratio range is 100% and the lower bound of the predetermined ratio range is 80%.

9. The brightness control method of claim 7, wherein a period of each cycle is larger than or equal to one minute.

10. The brightness control method of claim 6, wherein the display parameter comprises brightness, contrast, gamma value or combination thereof.
